(19) United States
(12) Patent Application Publication
(10) Pub. No.: US 2019/0391762 A1
(43) Pub. Date: Dec. 26, 2019

(54) MEMORY CONTROLLER, NON-VOLATILE STORAGE DEVICE, NON-VOLATILE STORAGE SYSTEM, AND MEMORY CONTROL METHOD

(71) Applicant: Panasonic Intellectual Property Management Co. Ltd., Osaka (JP)

(72) Inventors: Shigekazu KOGITA, Kanagawa (JP); Toshiyuki HONDA, Kyoto (JP); Hirokazu SO, Kyoto (JP); Masato SUTO, Osaka (JP)

(21) Appl. No.: 16/441,606

(22) Filed: Jun. 14, 2019

(30) Foreign Application Priority Data
Jun. 25, 2018 (JP) 2018-119902

(51) Int. Cl. G06F 3/06; G06F 12/10; G06F 12/02

(52) U.S. Cl. CPC G06F 3/0659; G06F 3/0604; G06F 2212/1008; G06F 12/10; G06F 12/0238; G06F 3/0673

(57) ABSTRACT

A memory controller includes an address converter configured to convert an address designated by a host device for writing and reading into a physical address of a non-volatile memory, and an invalid-area manager configured to manage an invalid area of the non-volatile memory, the address converter making no reference to the invalid area, and, upon receipt of an invalid-data read command from the host device, data in the invalid area, managed by the invalid-area manager, of the non-volatile memory is output to the host device.

### BACKGROUND

### 1. Technical Field

The present disclosure relates to a memory controller that controls a solid state drive (SSD), a semiconductor memory card, or the like including, as a data storage medium, a rewritable non-volatile memory such as a flash memory, a non-volatile storage device, a non-volatile storage system, and a memory control method.

### 2. Description of the Related Art

A non-volatile storage device including a rewritable non-volatile memory such as a flash memory is widely used as, for example, an SSD or a semiconductor memory card. Further, such a non-volatile storage device is now in increasing demand as a non-volatile storage system in which the non-volatile storage device is integrated into audiovisual equipment such as a personal computer or a digital camera.

Such an SSD or semiconductor memory card includes a flash memory where data is stored and a memory controller that controls the flash memory. The memory controller is a device that controls reading and writing of data from and to the flash memory in accordance with a read and write instruction from a host device such as a personal computer or a digital camera. In general, it is required that the flash memory be subjected to processes such as defect management (defect control), wear leveling (leveling of write cycles), and error correction processing using an error correction code (ECC), and such processes are under control of the memory controller. A typical example of the flash memory is a NAND-type flash memory.

In recent years, an electronic device such as a multifunction peripheral (MFP) holds confidential data such as image data in a storage device. Confidential data deemed unnecessary after being stored in the storage device is required to be physically discarded promptly from a security point of view. To meet the requirement, for example, PTL 1 discloses a technique of increasing security in which, upon receiving an instruction from a host device to completely delete data, a non-volatile storage device physically erases or overwrites the data deemed unnecessary.

### CITATION LIST

### Patent Literature

PTL 1: Unexamined Japanese Patent Publication No.2013-196164

### SUMMARY

In the above-described conventional method, however, even when the host device issues the instruction to the non-volatile storage device to physically erase or overwrite the data deemed unnecessary, the host device is unable to confirm the fact that the data has been erased or overwritten.

The present disclosure relates to a memory controller, a non-volatile storage device, a non-volatile storage system, and a memory control method that allow the host device to confirm whether the data deemed unnecessary has been physically erased or overwritten by outputting data present in an invalid area that the host device is unable to read through the use of a designated address.

A memory controller according to the present disclosure is capable of communicating with a host device and includes an address converter configured to convert an address designated by the host device for writing and reading into a physical address of a non-volatile memory, and an invalid-area manager configured to manage an invalid area of the non-volatile memory, the address converter making no reference to the invalid area, and, upon receipt of an invalid-data read command from the host device, data in the invalid area, managed by the invalid-area manager, of the non-volatile memory is output to the host device.

The memory controller, the non-volatile storage device, the non-volatile storage system, and the memory control method according to the present disclosure are useful in confirming whether data deemed unnecessary has been physically corrupted.

### BRIEF DESCRIPTION OF THE DRAWINGS

FIG. 1 is a configuration diagram of a non-volatile storage device according to a first exemplary embodiment;

FIG. 2 is a control block diagram of a memory controller;

FIG. 3 is a configuration diagram of a non-volatile memory;

FIG. 4 is a diagram showing a configuration example of a physical area serving as an allocation unit of a non-volatile memory;

FIG. 5 is a diagram showing an example of an address mapping table;

FIG. 6 is a diagram showing an example of an invalid-area management table;

FIG. 7 is a flowchart of an invalid-data read process;

FIG. 8 is a control block diagram of a memory controller according to a second exemplary embodiment;

FIG. 9 is a flowchart of a search process to be executed by the memory controller according to the second exemplary embodiment;

FIG. 10 is a control block diagram of a memory controller according to a third exemplary embodiment;

FIG. 11 is a flowchart of an invalid-area-hash read process to be executed by the memory controller according to the third exemplary embodiment;

FIG. 12 is a control block diagram of a memory controller according to a fourth exemplary embodiment; and

FIG. 13 is a flowchart of a hash search process to be executed by the memory controller according to the fourth exemplary embodiment.

### DETAILED DESCRIPTION

Exemplary embodiments will be described in detail below with reference to the drawings as appropriate. However, more detailed description than necessary may be omitted in some cases. For example, a detailed description of a well-known matter and a duplicated description of substantially the same configuration will be omitted in some cases. This is to prevent the following descriptions from being unnecessarily redundant and to help those skilled in the art to easily understand the following descriptions.

The inventor(s) of the present disclosure provides the accompanying drawings and the following descriptions to help those skilled in the art to fully understand the present disclosure and thus do not intend to limit the subject matter defined in the appended claims.

### First Exemplary Embodiment

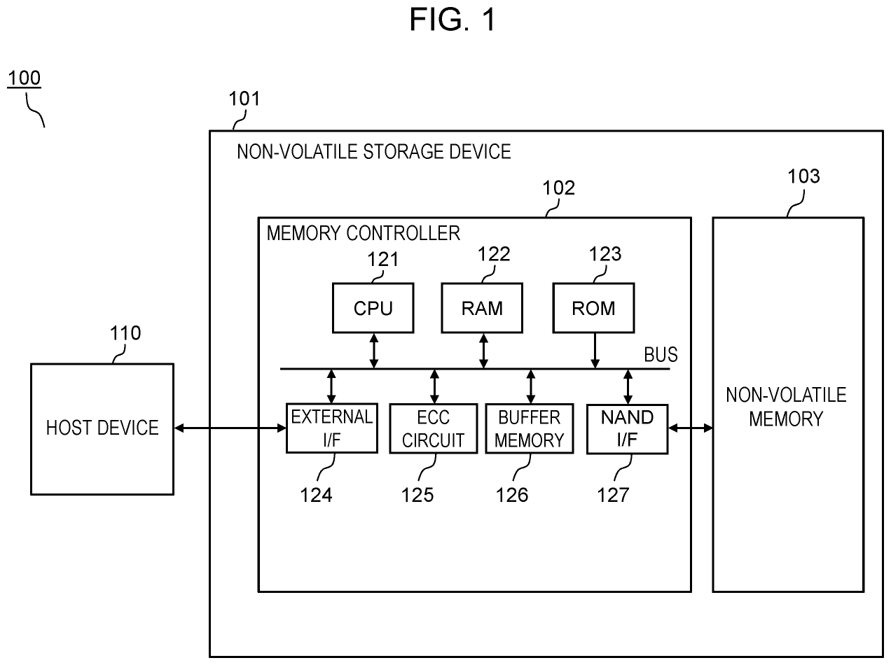

A first exemplary embodiment will be described below with reference to FIGS. 1 to 7.

### [1-1. Configuration]

### [1-1-1. Configuration of Memory Controller]

FIG. 1 is a configuration diagram showing a non-volatile storage device including a memory controller according to the present exemplary embodiment.

Non-volatile storage device 101 (an example of a non-volatile storage device) includes non-volatile memory 103 (an example of a non-volatile memory, such as a flash memory) where data is recorded and memory controller 102. In response to a command from host device 110, non-volatile storage device 101 writes and reads data to and from non-volatile memory 103. Non-volatile storage system 100 includes host device 110 and non-volatile storage device 101.

Memory controller 102 (an example of a memory controller) includes central processing unit (CPU) 121 (an example of a controller or processor) that is either a controller or a processor, random access memory (RAM) 122, read only memory (ROM) 123, external interface (external IT) 124 (an example of a connector), error correction code (ECC) circuit 125, buffer memory 126 (an example of a buffer), and NAND interface (NAND I/F) 127 (an example of a second connector), and these components are interconnected via a bus.

CPU 121 is a processing unit that executes a control program and the like. RAM 122 is used as a storage area and a work area for a program to be executed by CPU 121 and for parameters that are changed as needed while the program is in execution. ROM 123 is used for storing the program to be executed by CPU 121 or constant data serving as an operation parameter.

External I/F 124 is an interface that transmits and receives data to and from host device 110 under control of CPU 121.

ECC circuit 125 is a circuit that generates an error correction code of data to be stored in non-volatile memory 103 and corrects an error in data stored in non-volatile memory 103.

Buffer memory 126 is used for temporarily holding data to be written to and data read from host device 110, and data to be written to and data read from non-volatile memory 103.

NAND I/F 127 is an interface that writes and read data to and from non-volatile memory 103 under control of CPU 121.

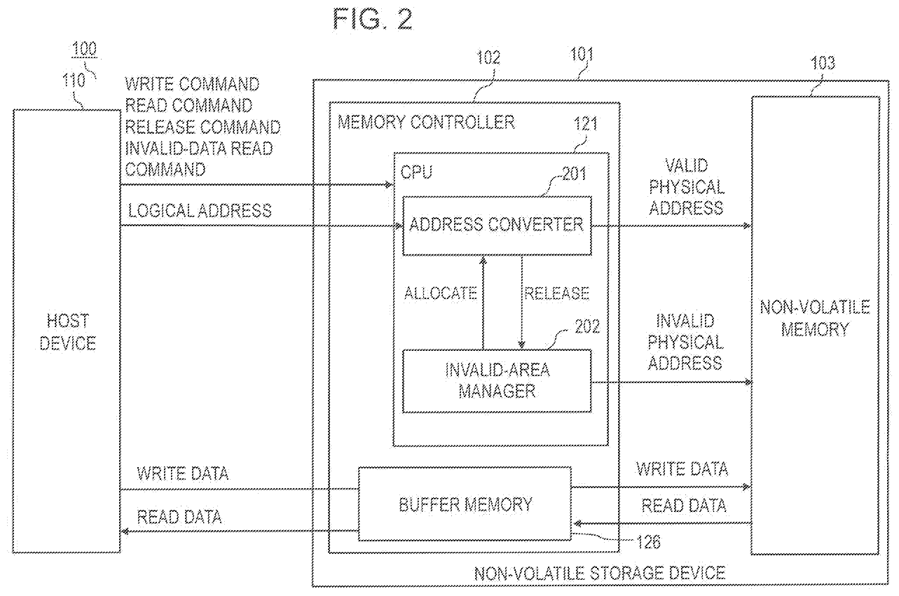

FIG. 2 is a diagram primarily showing control blocks of memory controller 102.

CPU 121 receives a write command, a read command, or the like from host device 110 via external I/F 124 to control transmission and reception of data to and from host device 110, issues an instruction for non-volatile memory 103 to write and read data, and controls non-volatile memory 103.

CPU 121 includes address converter 201 and invalid-area manager 202.

Address converter 201 converts an address (logical address) designated by host device 110 for writing or reading data into a corresponding valid physical address of non-volatile memory 103. Stored at such a valid physical address that address converter 201 makes reference to is valid data that host device 110 can read through the use of a designated logical address.

Invalid-area manager 202 manages invalid physical addresses that address converter 201 makes no reference to. Stored at such an invalid physical address is invalid data that host device 110 cannot read through the use of a designated logical address, specifically, old data before being overwritten or data in an erased state.

### [1-1-2. Configuration of Non-Volatile Memory]

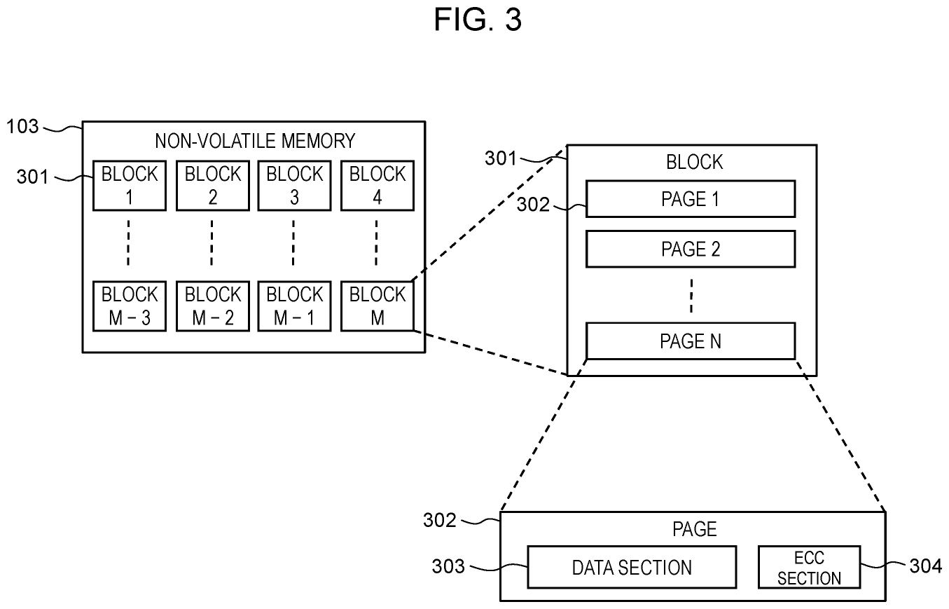

FIG. 3 is a configuration diagram showing the non-volatile memory according to the present exemplary embodiment.

Non-volatile memory 103 includes a plurality of blocks 301. Blocks 301 are units of a data erasure operation by which data is erased.

Each of blocks 301 includes a plurality of pages 302. Pages 302 are units of a data write operation or data read operation. In order to write data to non-volatile memory 103, erasure is performed on a block basis, and then the data is written to pages of the block in ascending order of the numbers of the pages.

Each of pages 302 includes data section 303 and ECC section 304. Data section 303 is an area where content data transmitted from host device 110 is stored. ECC section 304 is an area where an error correction code of the content data stored in data section 303 is stored. Memory controller 102 corrects an error bit in data stored in data section 303 based on the error correction code stored in ECC section 304.

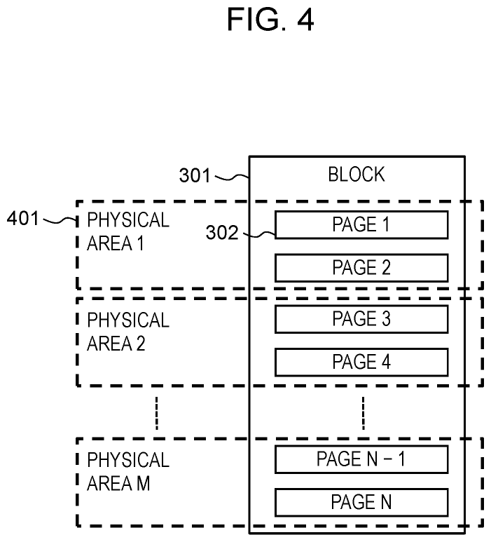

FIG. 4 shows a configuration example of physical area 401 that is a physical-area-allocation unit of the non-volatile memory according to the present exemplary embodiment.

In the configuration example shown in FIG. 4, physical area 401 includes two pages contiguous in a block. Note that the number of pages included in physical area 401 is not limited to two, but may be a different number. For example, physical area 401 may include: a plurality of pages selected from a plurality of blocks; a plurality of blocks; or a plurality of pages or blocks selected from a plurality of non-volatile memories.

### [1-1-3. Address Mapping Table]

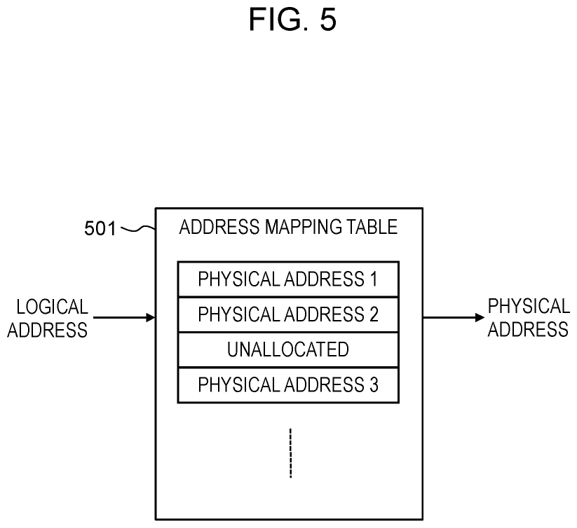

FIG. 5 shows a configuration example of an address mapping table that address converter 201 makes reference to for address conversion.

Address mapping table 501 is created, by CPU 121, on RAM 122 based on information stored in non-volatile memory 103 and serves as a table for converting a logical address to a corresponding physical address. In address mapping table 501, an entry corresponding to a logical address holds a physical address of a physical area allocated to the logical address. When no physical area is allocated to a logical address, an entry corresponding to the logical address holds a constant value representing “unallocated”. Such a configuration causes an entry corresponding to a logical address at which data has been written by host device 110 to hold a physical address of a physical area allocated to the logical address and causes an entry corresponding to a logical address from which a physical area has been released by host device 110 to hold the constant value representing “unallocated”.

Note that when address mapping table 501 is larger in size than RAM 122 and thus cannot be placed in its entirety on RAM 122, loading necessary portion of address mapping table 501 from information stored in non-volatile memory 103 onto RAM 122 as needed makes it possible to deploy address mapping table 501.

### [1-1-4. Configuration of Invalid-Area Management Table]

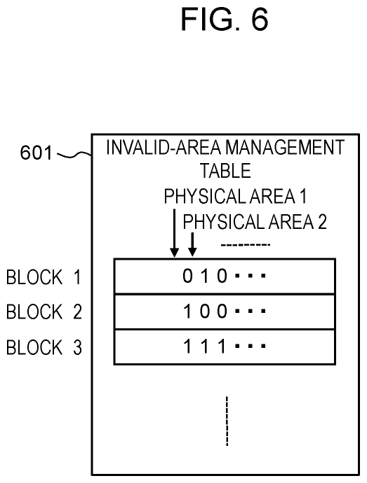

FIG. 6 shows a configuration example of an invalid-area management table that invalid-area manager 202 makes reference to for allocation or release of a physical area.

Invalid-area management table 601 is created, by CPU 121, on RAM 122 based on information stored in non-volatile memory 103 and serves as a table representing whether each physical area has been allocated (valid) to or released (invalid) from a logical address. In FIG. 6, a bit in invalid-area management table 601 set to 0 represents that a physical area associated with the bit is valid, and a bit set to 1 represents that a physical area associated with the bit is invalid.

Note that, in an example of the invalid-area management table shown in FIG. 6, whether physical areas are valid or invalid is represented in bitmap form, but a different form may be employed. For example, a list form may be employed in which invalid physical areas are listed, and the invalid-area management table can be constructed in such a form.

### [1-2. Command Process]

A description will be given below of an operation of memory controller 102 when host device 110 issues a write command, a read command, a release command, and an invalid-data read command shown in FIG. 2 to non-volatile storage device 101 in the present exemplary embodiment.

For the write command, the read command, and the release command, host device 110 transmits, to non-volatile storage device 101, each of the commands together with a logical address that is subjected to a corresponding process. For the invalid-data read command, no logical address is transmitted.

For the write command, host device 110 transmits write data to non-volatile storage device 101. For the read command and the invalid-data read command, host device 110 receives read data from non-volatile storage device 101. For the release command, data is neither transmitted nor received.

### [1-2-1. Write Command Process]

When non-volatile storage device 101 receives the write command and a logical address from host device 110, CPU 121 causes invalid-area manager 202 to make reference to invalid-area management table 601 to allocate an invalid physical area, makes a corresponding physical address valid, and causes address converter 201 to register the physical address of the physical area thus allocated with address mapping table 501 as a physical address corresponding to the logical address. When a different physical address has been registered before the above-described registration, invalid-area manager 202 is caused to make the physical address in invalid-area management table 601 invalid to release a physical area associated with the physical address. The write data is transmitted from host device 110 to non-volatile storage device 101 and then transmitted to non-volatile memory 103 through buffer memory 126, and written to the allocated physical area.

### [1-2-2. Read Command Process]

When non-volatile storage device 101 receives the read command and a logical address from host device 110, CPU 121 causes address converter 201 to make reference to address mapping table 501 to convert the logical address into a corresponding physical address of a physical area. Data in the physical area of the physical address that is a result of the conversion is read from non-volatile memory 103 and then transmitted, through buffer memory 126, to host device 110. When an entry of address mapping table 501 corresponding to the logical address indicates “unallocated”, default data is transmitted to host device 110. Examples of such default data include data in the erased state, data filled with 0, and data filled with 1, but the default data is not limited to these examples.

### [1-2-3. Release Command Process]

When non-volatile storage device 101 receives the release command and a logical address from host device 110, CPU 121 causes address converter 201 to change the logical address in address mapping table 501 to “unallocated”. Then, in order to release a physical area associated with a physical address already registered before being changed to “unallocated”, invalid-area manager 202 is caused to make the physical address in invalid-area management table 601 invalid.

The release command is equivalent to Trim of an SSD, for example. The use of the release command that enables physical erasure or overwriting on a released physical area makes it possible to increase security of non-volatile storage device 101. Further, another command that enables such physical erasure or overwriting, rather than as part of the release command process, may be provided to non-volatile storage device 101.

### [1-2-4. Invalid-Data Read Command Process]

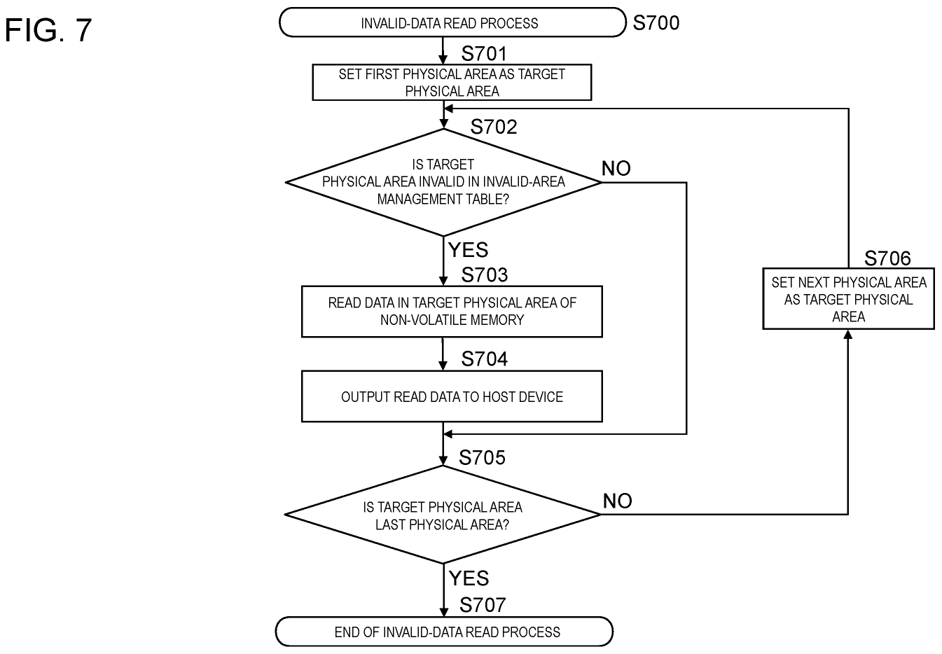

When non-volatile storage device 101 receives the invalid-data read command from host device 110, CPU 121 executes an invalid-data read process shown in FIG. 7.

A description will be given below of the invalid-data read process (S700) shown in FIG. 7.

First, the first physical area in invalid-area management table 601 is set as a target physical area (S701).

Then, a determination is made whether the target physical area is invalid in invalid-area management table 601 (S702).

When the target physical area is determined to be invalid in S702, data in the target physical area is read from non-volatile memory 103 to buffer memory 126 (S703), and the data thus read is output to host device 110 (S704).

When the target physical area is determined not to be invalid (determined to be valid) in S702, neither S703 nor S704 is executed.

Next, a determination is made whether the target physical area is the last physical area in invalid-area management table 601 (S705).

When the target physical area is determined not to be the last physical area in S705, the next physical area is set as the target physical area (S706), and the process is repeated after returning to S702.

When the target physical area is determined to be the last physical area in S705, the invalid-data read process is brought to an end (S707).

### [1-3. Effect and Other Benefits]

Memory controller 102 according to the present exemplary embodiment is a memory controller that writes and reads data to and from non-volatile memory 103 and includes NAND I/F 127 connected to non-volatile memory 103, and CPU 121. CPU 121 includes address converter 201 and invalid-area manager 202 as control blocks. When receiving the invalid-data read command from host device 110, memory controller 102 outputs, to host device 110, data in an invalid physical area managed by invalid-area manager 202.

This allows host device 110 to read, from non-volatile storage device 101, data in an invalid physical area that cannot be read through the use of a designated logical address and the read command. The data thus read can be used for host device 110 to confirm whether data to be physically erased or overwritten in terms of security is left in non-volatile memory 103.

### Second Exemplary Embodiment

### [2-1. Configuration]

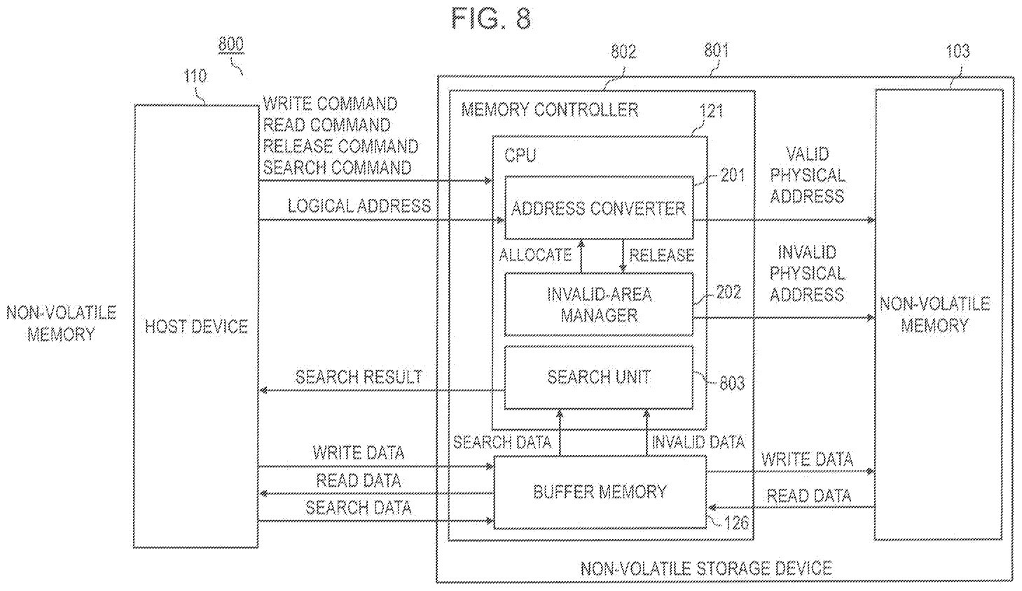

FIG. 8 is a diagram primarily showing control blocks of memory controller 802 according to a second exemplary embodiment. Note that components having the same configurations and capabilities as in the first exemplary embodiment are denoted by the same reference numerals, and detailed descriptions will be omitted. Non-volatile storage system 800 include host device 110 and non-volatile storage device 801.

As shown in FIG. 8, CPU 121 includes address converter 201, invalid-area manager 202, and search unit 803.

Address converter 201 and invalid-area manager 202 have the same configurations and capabilities as in the first exemplary embodiment.

Search unit 803 sequentially reads data from invalid physical areas of non-volatile memory 103 to buffer memory 126, searches the data for search data received from host device 110, and outputs a search result to host device 110.

### [2-2. Command Process]

A description will be given below of an operation of memory controller 802 when host device 110 issues a write command, a read command, a release command, and a search command shown in FIG. 8 to non-volatile storage device 801 in the present exemplary embodiment.

The write command, the read command, the release command have the same capabilities and operations as in the first exemplary embodiment.

For the search command, no logical address is transmitted from host device 110 to non-volatile storage device 801.

For the search command, the search data is transmitted from host device 110 to non-volatile storage device 801.

### [2-2-1. Search Command Process]

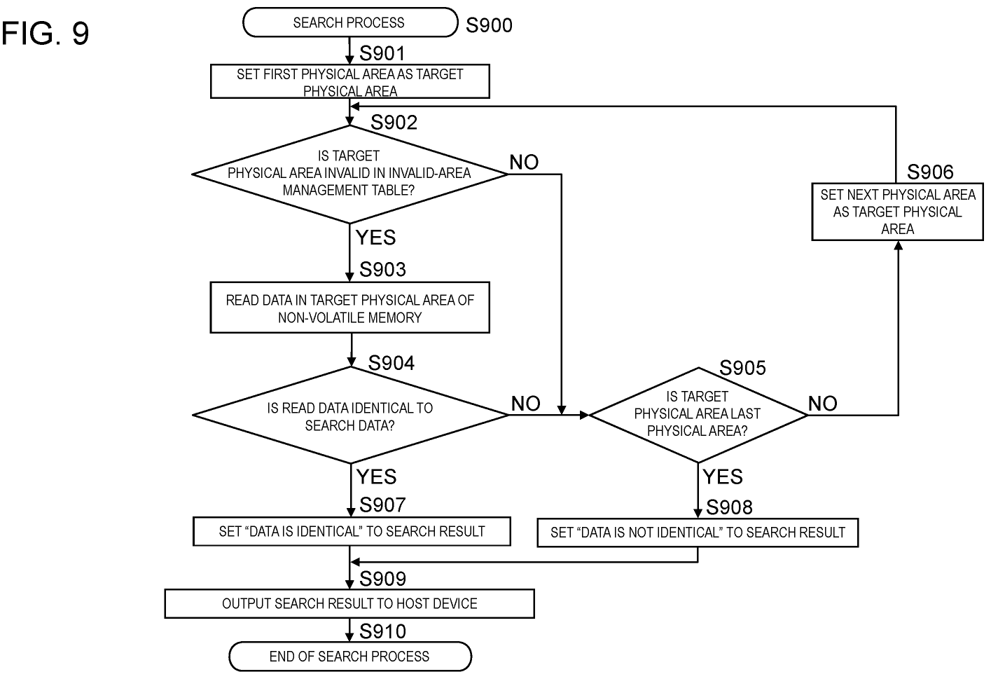

When non-volatile storage device 801 receives the search command and the search data from host device 110, CPU 121 executes a search process shown in FIG. 9.

A description will be given below of the search process (S900) shown in FIG. 9.

First, the first physical area in invalid-area management table 601 is set as a target physical area (S901).

Then, a determination is made whether the target physical area is invalid in invalid-area management table 601 (S902).

When the target physical area is determined to be invalid in S902, data in the target physical area is read from non-volatile memory 103 to buffer memory 126 (S903), and a determination is made whether the data thus read is identical to the search data (S904).

When the data read in S903 is determined not to be identical to the search data or the target physical area is determined not to be invalid (determined to be valid) in S902, a determination is made whether the target physical area is the last physical area in invalid-area management table 601 (S905).

When the target physical area is determined not to be the last physical area in S905, the next physical area is set as the target physical area (S906), and the process is repeated after returning to S902.

When the data read in S903 is determined to be identical to the search data, the search result is set as “data is identical” (S907).

When the target physical area is determined to be the last physical area in S905, the search result is set as “data is not identical” (S908).

After being set in S907 or S908, the search result is output to host device 110 (S909), and the search process is brought to an end (S910).

Note that when the search data is identical in size to the physical area, the determination of whether data is identical can be made in S904, but when the search data is different in size from the physical area, the determination of whether data is identical cannot be made. However, when, for example, the search data is smaller in size than the physical area, making the size of the physical area an integral multiple of the size of the search data and dividing the physical area into a plurality of segment areas identical in size to the search data allows a determination of whether the search data is identical to at least one of the segment areas of the physical area.

### [2-3. Effects and Other Benefits]

Memory controller 802 according to the present exemplary embodiment is a memory controller that writes and reads data to and from non-volatile memory 103 and includes NAND IT 127 connected to non-volatile memory 103, and CPU 121. CPU 121 includes address converter 201, invalid-area manager 202, and search unit 803 as control blocks. When receiving the search command and the search data from host device 110, memory controller 802 searches data in invalid physical areas managed by invalid-area manager 202 for data identical to the search data, and outputs a search result to the host device 110.

This allows host device 110 to receive, from non-volatile storage device 801, the search result indicating whether data identical to the search data is present in invalid physical areas that cannot be read through the use of a designated logical address and the read command. With data to be physically erased or overwritten in terms of security set as the search data, the search result thus received can be used for host device 110 to confirm whether data to be physically erased or overwritten in terms of security is left in non-volatile memory 103.

Moreover, in the second exemplary embodiment, only the search result rather than data in invalid physical areas needs to be transmitted from non-volatile storage device 801 to host device 110, making it possible to reduce communication traffic between non-volatile storage device 801 and host device 110, as compared with the first exemplary embodiment.

Furthermore, in the second exemplary embodiment, only the transmission of the search data from host device 110 to non-volatile storage device 801 without the transmission of data in invalid physical areas from non-volatile storage device 801 to host device 110 needs to be made, preventing a third party, even when data to be physically erased or overwritten in terms of security is left in invalid physical areas of non-volatile memory 103, from reading such data, as compared with the first exemplary embodiment.

### Third Exemplary Embodiment

### [3-1. Configuration]

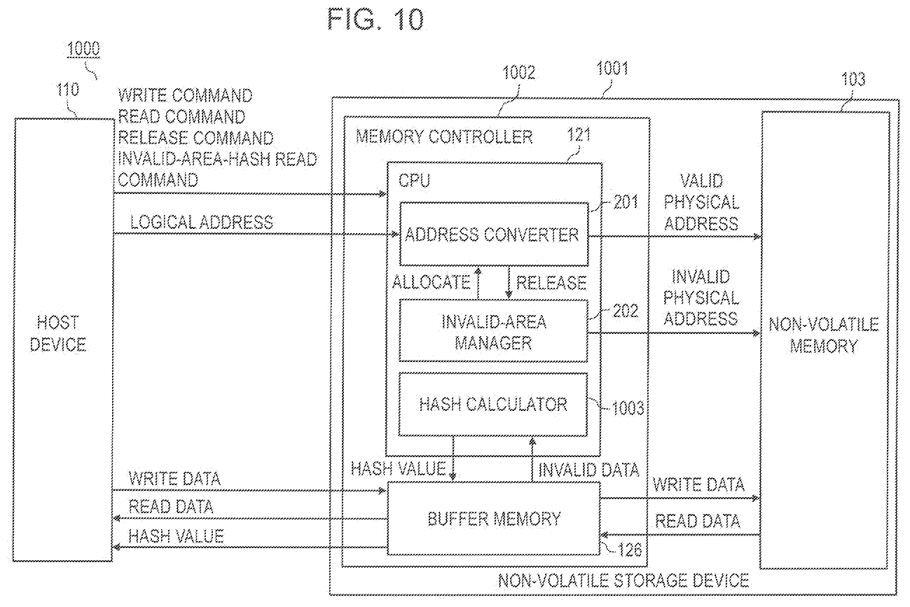

FIG. 10 is a diagram primarily showing control blocks of memory controller 1002 according to a third exemplary embodiment. Note that components having the same configurations and capabilities as in the first exemplary embodiment are denoted by the same reference numerals, and detailed descriptions will be omitted. Non-volatile storage system 1000 include host device 110 and non-volatile storage device 1001.

As shown in FIG. 10, CPU 121 includes address converter 201, invalid-area manager 202, and hash calculator 1003.

Address converter 201 and invalid-area manager 202 have the same configurations and capabilities as in the first exemplary embodiment.

Hash calculator 1003 calculates a hash value of data read from non-volatile memory 103 to buffer memory 126.

### [3-2. Command Process]

A description will be given below of an operation of memory controller 1002 when host device 110 issues a write command, a read command, a release command, and an invalid-area-hash read command shown in FIG. 10 to non volatile storage device 1001 in the present exemplary embodiment.

The write command, the read command, the release command have the same capabilities and operations as in the first exemplary embodiment.

For the invalid-area-hash read command, no logical address is transmitted from host device 110 to non-volatile storage device 1001.

For the invalid-area-hash read command, host device 110 receives a hash value from non-volatile storage device 1001.

### [3-2-1. Invalid-Area-Hash Read Command Process]

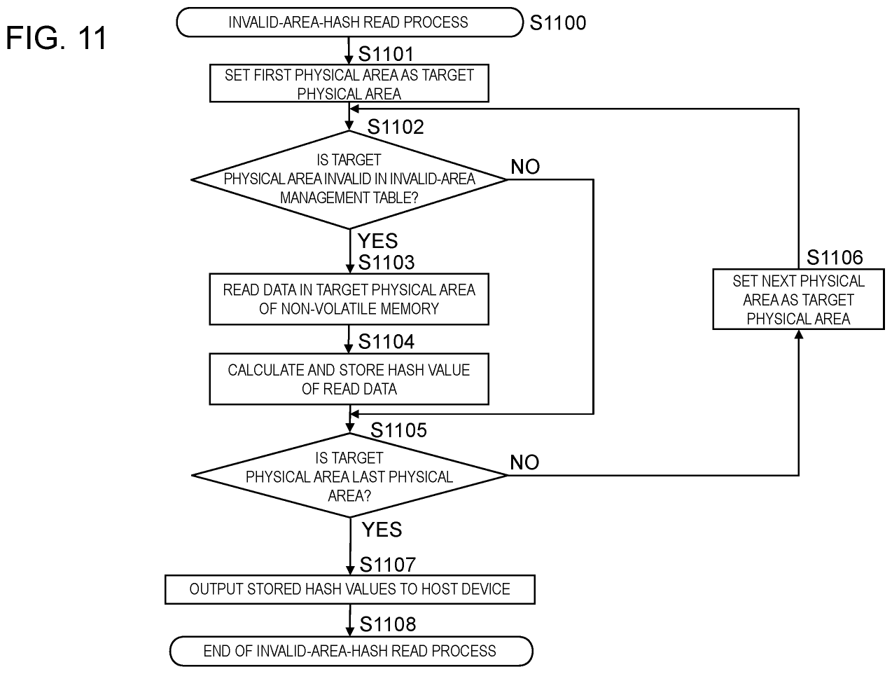

When non-volatile storage device 1001 receives the invalid-area-hash read command from host device 110, CPU 121 executes an invalid-area-hash read process shown in FIG. 11.

A description will be given below of the invalid-area-hash read process (S1100) shown in FIG. 11.

First, the first physical area in invalid-area management table 601 is set as a target physical area (S1101).

Then, a determination is made whether the target physical area is invalid in invalid-area management table 601 (S1102).

When the target physical area is determined to be invalid in S1102, data in the target physical area is read from non-volatile memory 103 to buffer memory 126 (S1103), and hash calculator 1003 calculates a hash value of the data thus read and stores the has value in buffer memory 126 (S1104).

When the target physical area is determined not to be invalid (determined to be valid) in S1102, neither S1103 nor S1104 is executed.

Next, a determination is made whether the target physical area is the last physical area in invalid-area management table 601 (S1105).

When the target physical area is determined not to be the last physical area in S1105, the next physical area is set as the target physical area (S1106), and the process is repeated after returning to S1102.

When the target physical area is determined to be the last physical area in S1105, the hash values stored in buffer memory 126 are output to host device 110 (S1107), and the invalid-area-hash read command process is brought to an end (S1108).

### [3-3. Effects and Other Benefits]

Memory controller 1002 according to the present exemplary embodiment is a memory controller that writes and reads data to and from non-volatile memory 103 and includes NAND IT 127 connected to non-volatile memory 103, and CPU 121. CPU 121 includes address converter 201, invalid-area manager 202, and hash calculator 1003 as control blocks. When receiving the invalid-area-hash read command from host device 110, memory controller 1002 sequentially calculates and stores hash values of data in invalid physical areas managed by invalid-area manager 202 and output the hash values thus stored to host device 110.

This allows host device 110 to receive, from non-volatile storage device 1001, hash values of data in invalid physical areas that cannot be read through the use of a designated logical address and the read command. Host device 110 calculates a hash value of data to be physically erased or overwritten in terms of security and compares the hash value with each of the hash values received from non-volatile storage device 1001, so as to be able to confirm whether data to be physically erased or overwritten in terms of security is possibly left in non-volatile memory 103.

Moreover, in the third exemplary embodiment, only the hash values rather than data in invalid physical areas need to be transmitted from non-volatile storage device 1001 to host device 110, making it possible to reduce communication traffic between non-volatile storage device 1001 and host device 110 as compared with the first exemplary embodiment.

Furthermore, in the third exemplary embodiment, only the hash values rather than data in invalid physical areas need to be transmitted from non-volatile storage device 1001 to host device 110, preventing a third party, even when data to be physically erased or overwritten in terms of security is left in invalid physical areas of non-volatile memory 103, from reading such data.

Note that typical examples of a hash function used in hash calculation include SHA-1, SHA-2, MD5, and the like, but the hash function available in the present disclosure is not limited to these examples.

Note that when buffer memory 126 is not large enough in capacity, the transfer of the hash values from non-volatile storage device 1001 to host device 110 can be divided into a plurality of transfers.

### Fourth Exemplary Embodiment

### [4-1. Configuration]

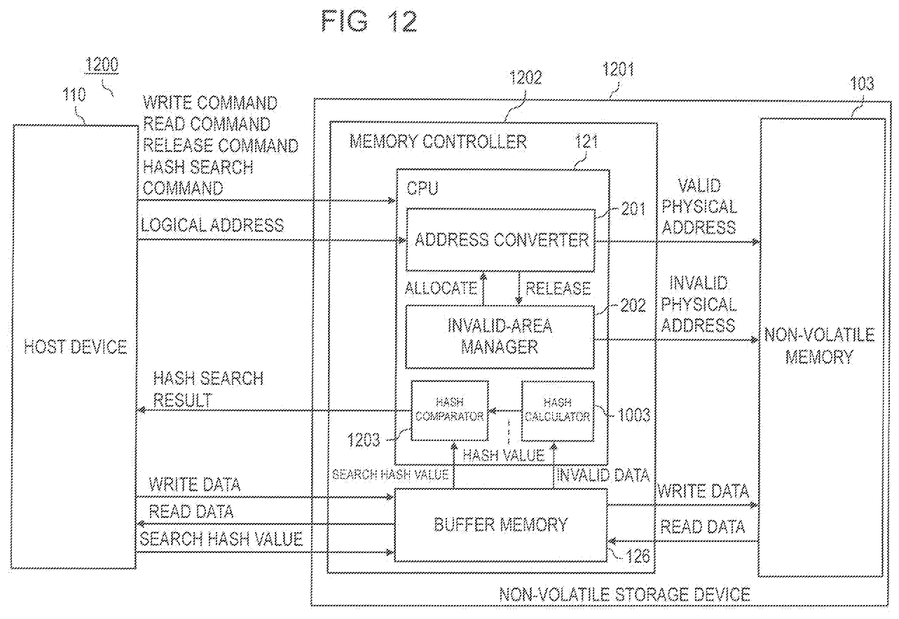

FIG. 12 is a diagram primarily showing control blocks of memory controller 1202 according to a fourth exemplary embodiment. Note that components having the same configurations and capabilities as in the first exemplary embodiment are denoted by the same reference numerals, and detailed descriptions will be omitted. Non-volatile storage system 1200 includes host device 110 and non-volatile storage device 1201.

As shown in FIG. 12, CPU 121 includes address converter 201, invalid-area manager 202, hash calculator 1003, and hash comparator 1203.

Address converter 201 and invalid-area manager 202 have the same configurations and capabilities as in the first exemplary embodiment.

Hash calculator 1003 has the same configuration and capability as in the third exemplary embodiment.

Hash comparator 1203 compares each of hash values sequentially calculated by hash calculator 1003 with a hash value transmitted from host device 110 to buffer memory 126 and stores a comparison result as a hash search result.

### [4-2. Command Process]

A description will be given below of an operation of memory controller 1202 when host device 110 issues a write command, a read command, a release command, and a hash search command shown in FIG. 12 to non-volatile storage device 1201 in the present exemplary embodiment.

The write command, the read command, the release command have the same capabilities and operations as in the first exemplary embodiment.

For the hash search command, no logical address is transmitted from host device 110 to non-volatile storage device 1201.

For the hash search command, host device 110 transmits a search hash value to non-volatile storage device 1201 and receives the hash search result from non-volatile storage device 1201.

### [4-2-1. Hash Search Process]

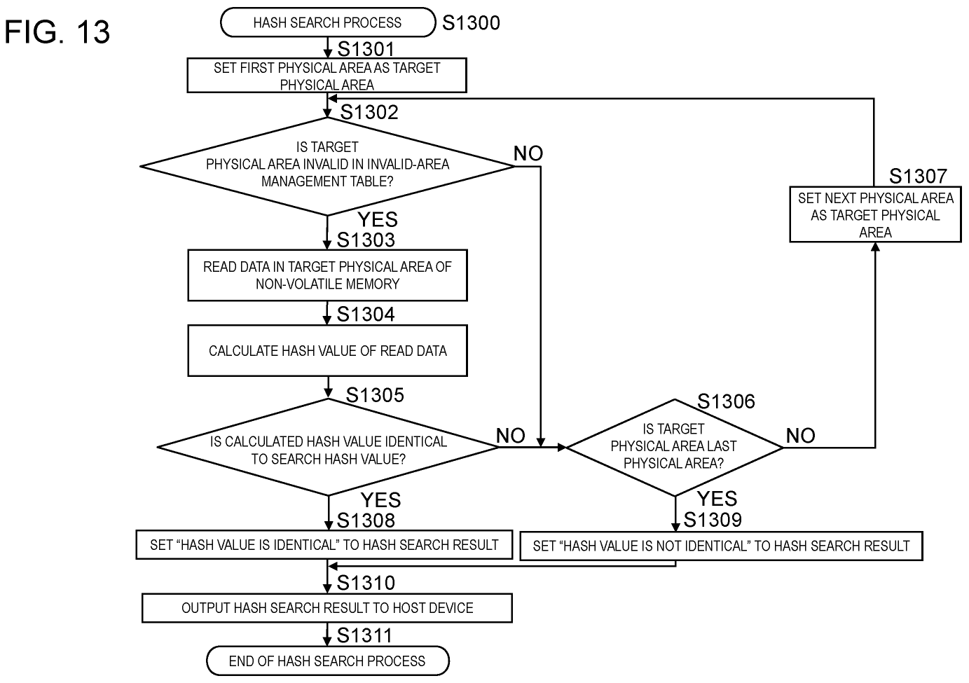

When non-volatile storage device 1201 receives the hash search command and the search hash value from host device 110, CPU 121 executes a hash search process shown in FIG. 13.

A description will be given below of the hash search process (S1300) shown in FIG. 13.

First, the first physical area in invalid-area management table 601 is set as a target physical area (S1301).

Then, a determination is made whether the target physical area is invalid in invalid-area management table 601 (S1302).

When the target physical area is determined to be invalid in S1302, data in the target physical area is read from non-volatile memory 103 to buffer memory 126 (S1303), and hash calculator 1003 calculates a hash value of the data thus read (S1304).

A determination is made whether the hash value calculated in S1304 is identical to the search hash value received from host device 110 (S1305).

When the hash value calculated in S1304 is determined not to be identical to the search hash value or the target physical area is determined not to be invalid (determined to be valid) in S1302, a determination is made whether the target physical area is the last physical area in invalid-area management table 601 (S1306).

When the target physical area is determined not to be the last physical area in S1306, the next physical area is set as the target physical area (S1307), and the process is repeated after returning to S1302.

When the hash value calculated in S1304 is determined to be identical to the search hash value, “hash value is identical” is set to the hash search result (S1308).

When the target physical area is determined to be the last physical area in S1306, “hash value is not identical” is set to the hash search result (S1309).

After being set in S1308 or S1309, the hash search result is output to host device 110 (S1310), and the hash search process is brought to an end (S1311).

Note that when source data of which the search hash value is calculated is identical in size to the physical area, a desired hash search result can be obtained through the calculation of the hash value of data in the physical area in S1304 and the determination of whether the hash value is identical in S1305, but when the source data of which the search hash value is calculated is different in size from the physical area, a desired hash search result cannot be obtained only through the calculation of the hash value and the determination of whether the hash value is identical. However, when, for example, the source data of which the search hash value is calculated is smaller in size than the physical area, making the size of the physical area an integral multiple of the size of the source data of which the search hash value is calculated and dividing the physical area into a plurality of segment areas identical in size to the source data of which the search hash value is calculated allows a determination of whether the search hash value is identical to a hash value of at least one of the segment areas of the physical area.

### [4-3. Effects and Other Benefits]

Memory controller 1202 according to the present exemplary embodiment is a memory controller that writes and reads data to and from non-volatile memory 103 and includes NAND I/F 127 connected to non-volatile memory 103, and CPU 121. CPU 121 includes address converter 201, invalid-area manager 202, hash calculator 1003, and hash comparator 1203 as control blocks. When receiving the hash search command and the search hash value from host device 110, memory controller 1202 sequentially calculates hash values of data in invalid physical areas managed by invalid-area manager 202, compares each of the hash values thus calculated with the search hash value, stores a comparison result as a hash search result, and outputs the hash search result to host device 110.

This allows host device 110 to receive, from non-volatile storage device 1201, the hash search result indicating whether any one of the hash values of data in invalid physical areas that cannot be read through the use of a designated logical address and the read command is identical to the search hash value. With data to be physically erased or overwritten in terms of security set as the source data of which the search hash value is calculated, the hash search result thus received can be used for host device 110 to confirm whether data to be physically erased or overwritten in terms of security is possibly left in non-volatile memory 103.

Furthermore, in the fourth exemplary embodiment, only the hash search result rather than hash values of data in invalid physical areas needs to be transmitted from non-volatile storage device 1201 to host device 110, making it possible to reduce communication traffic between non-volatile storage device 1201 and host device 110 as compared with the third exemplary embodiment.

### Other Exemplary Embodiments

As described above, the first to fourth exemplary embodiments have been described as examples of the technique disclosed in the present application.

However, the technique of the present disclosure is not limited to the first to fourth exemplary embodiments, and also applicable to other exemplary embodiments that undergo some modifications, replacements, additions, and omissions, or the like, as appropriate.

The functional blocks of each of memory controllers 102, 802, 1002, 1202 described in the first to fourth exemplary embodiments may be implemented on a single chip constituted by a semiconductor device such as a large-scale integrated (LSI) circuit or may be partially or entirely implemented on a single chip. Although the term LSI is used herein, any one of the terms IC, VLSI, ULSI, and system LSI may be used depending on the degree of integration. The circuit integration is not limited to the LSI and may be achieved by dedicated circuitry or a general-purpose processor. A field programmable gate array (FPGA) that is programmable after an LSI circuit is manufactured, or a reconfigurable processor in which, after an LSI circuit is manufactured, connection or setting of circuit cells in the LSI circuit is reconfigurable may be used.

The process of each of the functional blocks of the first to fourth exemplary embodiments may be executed by a program.

An execution order of the processes and methods according to the first to fourth exemplary embodiments is not necessarily limited to the order described in the above exemplary embodiments, and the execution order may be changed without departing from the gist of the present disclosure.

Memory controllers 102, 802, 1002, 1202 according to the first to fourth exemplary embodiments, non-volatile storage devices 101, 801, 1001, 1201 that respectively include memory controllers 102, 802, 1002, 1202 and non-volatile memory 103, non-volatile storage systems 100, 800, 1000, 1200 that respectively include non-volatile storage devices 101, 801, 1001, 1201 and host device 110, a memory control method of non-volatile memory 103 to be executed according to the first to fourth exemplary embodiments, a computer program causing a computer to execute the memory control method, and a computer-readable recording medium recording the program lie within the scope of the present disclosure. Examples of such a computer-readable recording medium include a flexible disk, a hard disk, an optical disc, and a semiconductor memory.

The above computer program is not limited to a program recorded in the above recording medium but may be a program transmitted through an electric communication line, a wireless or wired communication line, a network represented by the internet, or the like.

As described above, the exemplary embodiments have been described as examples of the technique of the present disclosure. For this purpose, the accompanying drawings and the detailed description have been provided.

Therefore, in order to illustrate the above technique, the components described in the accompanying drawings and the detailed description may include not only components that are essential for solving the problem but also components that are not essential for solving the problem. For this reason, it should not be immediately deemed that those components that are not essential are essential just because those components that are not essential are described in the accompanying drawings and the detailed description.

Moreover, since the exemplary embodiments described above have been given to exemplify the technique of the present disclosure, various modifications, replacements, additions, omissions, or the like can be made within the scope of the claims or their equivalents.

The non-volatile storage device and the non-volatile storage system according to the present disclosure are applicable to an electronic device such as an MFP, a photocopier, a printer, a scanner, or a fax machine.

What is claimed is:

1. A memory controller capable of communicating with a host device and configured to write and read data to and from a non-volatile memory having a plurality of areas in accordance with an instruction from the host device, the memory controller comprising:
an address converter configured to convert an address designated for writing and reading to and from the host device into a physical address of one of the areas of the non-volatile memory; and
an invalid-area manager configured to manage an invalid area of the areas of the non-volatile memory, the address converter making no reference to the invalid area,
wherein upon receipt of an invalid-data read command from the host device, the data in the invalid area, managed by the invalid-area manager, of the areas of the non-volatile memory is output to the host device.

2. A memory controller capable of communicating with a host device and configured to write and read data to and from a non-volatile memory having a plurality of areas in accordance with an instruction from the host device, the memory controller comprising:
an address converter configured to convert an address designated for writing and reading to and from the host device into a physical address of one of the areas of the non-volatile memory;
an invalid-area manager configured to manage an invalid area of the areas of the non-volatile memory, the address converter making no reference to the invalid area; and
a search unit configured to search the data in the areas of the non-volatile memory for specific data,
wherein upon receipt of search data from the host device, the search unit searches the data in the invalid area, managed by the invalid-area manager, of the areas of the non-volatile memory for the search data and outputs a search result to the host device.

3. A memory controller capable of communicating with a host device and configured to write and read data to and from a non-volatile memory having a plurality of areas in accordance with an instruction from the host device, the memory controller comprising:
an address converter configured to convert an address designated for writing and reading to and from the host device into a physical address of one of the areas of the non-volatile memory;
an invalid-area manager configured to manage an invalid area of the areas of the non-volatile memory, the address converter making no reference to the invalid area; and
a hash calculator configured to calculate a hash value of the data,
wherein upon receipt of an invalid-area-hash read command from the host device, the hash calculator calculates the hash value of the data in the invalid area, managed by the invalid-area manager, of the areas of the non-volatile memory and outputs the hash value to the host device.

4. A memory controller capable of communicating with a host device and configured to write and read data to and from a non-volatile memory having a plurality of areas in accordance with an instruction from the host device, the memory controller comprising:
an address converter configured to convert an address designated for writing and reading to and from the host device into a physical address of one of the areas of the non-volatile memory;
an invalid-area manager configured to manage an invalid area of the areas of the non-volatile memory, the address converter making no reference to the invalid area;
a hash calculator configured to calculate a hash value of the data; and
a hash comparator configured to compare the hash value received from the host device with the hash value output from the hash calculator,
wherein upon receipt of the hash value from the host device, the hash calculator calculates the hash value of the data in the invalid area, managed by the invalid-area manager, of the areas of the non-volatile memory, and the hash comparator compares the hash value received from the host device with the hash value calculated by the hash calculator and outputs a comparison result to the host device.

5. A non-volatile storage device comprising:
the memory controller according to claim 1; and
the non-volatile memory connected to the memory controller.

6. A non-volatile storage system comprising:
the non-volatile storage device according to claim 5; and
the host device configured to make the writing and the reading of the data to and from the non-volatile storage.

7. A memory control method causing a processor to make writing and reading to and from a non-volatile memory having a plurality of areas in accordance with an instruction from outside, the memory control method comprising:
converting an address designated for writing and reading to and from the outside into a physical address of one of the areas of the non-volatile memory;
managing an invalid area of the areas of the non-volatile memory, the physical address of the invalid area not being associated with a conversion result of the address designated from the outside; and
outputting information on data in the invalid area of the areas of the non-volatile memory in accordance with a command from the outside.
